(19) United States
(12) Patent Application Publication
(10) Pub. No.: US 2025/0157356 A1
(43) Pub. Date: May 15, 2025

(54) System and Method for Configuring a Vehicle as a Driving Simulation User Interface

(71) Applicant: Vincent Loccisano, Wellesley, MA (US)

(72) Inventor: Vincent Loccisano, Wellesley, MA (US)

(21) Appl. No.: 19/024,708

(22) Filed: Jan. 16, 2025

(51) Int. Cl. G09B 9/042; G02B 27/01; G09B 9/05

(52) U.S. Cl. CPC G09B 9/042; G09B 9/05; G02B 27/0101

(57) ABSTRACT

A system and method for adapting a conventional vehicle to a driving simulator uses the vehicle's actual components in a simulation for training or game-racing purposes. The system and method has a simulation control unit with a user-interface module that communicates with a vehicle's brakes, accelerator, clutch, steering wheel, instrument cluster and other components to create a driving simulation that may be projected onto the vehicle's windscreen, windows and mirrors. Haptic feedback is communicated to the driver from the simulator through vehicle components, such as steering wheel and pedals, to simulate the feel of driving conditions and scenarios.

### TECHNICAL FIELD

This disclosure relates to methods, systems or devices for configuring an existing vehicle as a user interface for driving training and simulation as instruction for new drivers, and for racing simulation. A vehicle's brakes, accelerator, clutch, steering wheel and instrument cluster may be configured to deliver accurate feedback to the driver, as well as projected images on the vehicle's windscreen, windows or mirrors, to provide a training simulator.

### BACKGROUND OF THE INVENTION

Driving simulators are sophisticated devices that replicate the experience of driving a vehicle in a controlled environment. These simulators use advanced technology to create realistic cockpits including steering wheels, brake, clutch and accelerator pedals, plus immersive displays, to create a realistic driving experience. Driving simulators are used for driver training, accident-simulation and avoidance training, and racing simulation. By providing a safe, controlled environment, driving simulators enable individuals to practice driving skills, learn traffic rules and gain experience in various driving scenarios without the risks involved in driving.

Driving simulators are valuable tools in driver training and research. Traditional driving simulators often require complex setups with specialized hardware and software, which can be expensive. Traditional driving simulators are by their nature not realistic—they don't use actual vehicle controls. Using the actual vehicle as the human interface for driving training or racing simulations can provide a realistic, immersive, and cost-effective solution. This method would employ a vehicle's existing controls and displays to enhance the training experience and improve driver skills.

Automobile electronics, including computers, electrical cables, and software protocols, are together known as a controller-area network (CAN), or CANbus. A CAN is a vehicle's main computer system. Through the CANbus, data travels through the system to the many subsystems such as those controlling the engine, the transmission, doors, windows, and other subsystems. Each of these subsystems is controlled by an electronic control unit (ECU). Current vehicles may have fifty or more ECUs, each able to sense signals indicating, for example: acceleration at various angles; voltage; pressure; braking; vehicle roll and yaw; steering angle; temperature, and other variables. The CANbus routes signals from sensors to computers as communicated by each ECU. An ECU can monitor voltage used by a subsystem and communicate that information through the CANbus to actuate, for instance, stopping a power-sliding door from closing on a passenger's limb, or adjusting a fuel injector's performance.

Adding to or changing a vehicle's electronic features once required extensive wiring. With the development of CAN in the last forty years, feature development (such as adding passenger-controlled climate options) has become physically easier because each new feature can now be added by programming the new computer code into the CAN. Now, all vehicle features as well as vehicle diagnostics are controlled via CAN, which uses a standardized protocol called OBD-II. New features can be integrated into a vehicle by developing and uploading an algorithm into the vehicle's CAN.

Compared with traditional liquid crystal displays (LCDs), organic light-emitting diode (OLED) displays have a thinner form factor and higher energy-efficiency. OLEDs are self-emissive; each pixel individually produces light. This allows for perfect blacks, high-contrast ratios, and wider viewing angles than possible with traditional LCDs.

Laser-projection displays offer significant advantages over traditional display technologies including wider color gamuts, higher contrast ratios and the ability to project onto non-planar surfaces. These systems use lasers as light sources to generate images, enabling sharp focus and considerable depth of field compared to conventional lamp-based projectors. Laser projection has applications in home theaters, large-venue displays and heads-up displays.

Vehicle computer networks are now evolving to work with other network protocols, including Local Interconnect Networks (LIN) and FlexRay, which are network protocols designed for vehicles, as well as Ethernet.

Road racing is performed on a purpose-built circuit with a variety of corners, straights and elevation changes. The goal in road racing is to complete a set number of laps around a closed, paved circuit in the fastest time possible. Vehicles are designed for speed, handling and braking on paved surfaces.

Dragstrip racing is performed on a straight, paved track with two or more lanes. Many tracks are a quarter-mile long. A dragstrip racer aims to accelerate from a standing start to the finish line in the shortest time. Vehicles are purpose-built vehicles with powerful engines designed for maximum acceleration.

Drifting is performed on a variety of paved courses that have tight corners and transitions. Vehicles are rear-wheel drive with modifications to enhance oversteer and control. The goal is to demonstrate control, precision and showmanship as drivers initiate and maintain drifts while navigating the course.

Off-road racing is performed on natural terrain such as deserts, forests, mountains or purpose-built off-road tracks with obstacles like jumps, rocks and mud. The vehicles are commonly trucks, buggies or other specialized vehicles with modifications for off-road durability. The goal is to navigate and adapt to changing terrain in the fastest time.

Rock-crawling racing is performed on courses with large rocks, steep inclines and other similar obstacles. Modified, four-wheel drive vehicles have specialized suspensions, tires and other modifications. The goal is to demonstrate precise driving, vehicle control and careful planning of each move.

Rally racing is performed on public roads or off-road stages with varying terrains that are closed to ordinary traffic. Vehicles are heavily modified production cars fitted for performance and durability. The goal is to complete a series of timed stages on the course.

Driving simulators may be realistic but fall short of being an actual vehicle.

### SUMMARY OF THE INVENTION

A system and method for adapting a conventional vehicle to a driving simulator uses the vehicle's actual components in a simulation for training or game-racing purposes. The system and method has a simulation control unit with a user-interface module that communicates with a vehicle's brakes, accelerator, clutch, steering wheel, instrument cluster and other components to create a driving simulation that may be projected onto the vehicle's windscreen, windows and mirrors. Haptic feedback is communicated to the driver from the simulator through vehicle components, such as steering wheel and pedals, to simulate the feel of driving conditions and scenarios.

The vehicle may interface with various racing-simulation games. One skilled in the art is familiar with modern games like Xbox or Iracing, and further understands that new racing games are frequently in development and may also be interfaced with, thereby allowing a user of this invention to compete in a racing simulation. Some methods of the embodiment function as a stand-alone game while other methods function as an off-season training opportunity.

In an example embodiment, one or more individuals may use a vehicle outfitted with the embodiment and be wirelessly connected to other users to virtually race remotely. In another example, a vehicle manufacturer may offer a racing series associated with a specific make or model of vehicle. A number of owners of a specific vehicle model, or specific model and year, my subscribe to a product provided by the manufacturer for virtual racing of similar vehicles. One skilled in the art understands that the term “racing” may refer to road racing, dragstrip, drifting, off road, rock climbing, rally racing and the like.

Many modern vehicles have hardware and software that enables the delivery of haptic feedback to an operator. For example, vehicles with lane-assist or automated self-driving deliver haptic feedback to a user through the steering wheel to make them aware of road conditions or driver-input requirements. These existing haptic feedback controls may be repurposed for the present invention.

In some embodiments, a simulation control unit is electronically coupled to the vehicle CANbus and collects signals from various vehicle sensors to inform software in the simulation control unit, which in turn directs signals to the vehicle interface module, projection system, feedback mechanisms and user interface. In an example embodiment, existing electric steering systems may readily provide haptic feedback without the need to physically move the vehicle's front wheels. Existing vehicles may further provide feedback through the brake pedal (in keeping with existing ABS warnings).

One skilled in the art understands that features and functions that respond to accelerator and brake pedals may similarly apply to a clutch pedal and a gear shift in a manual-transmission vehicle.

### BRIEF DESCRIPTION OF DRAWINGS

FIG. 1 is an illustration of a vehicle interior in combination with an example embodiment.

FIG. 2 is a diagram of a set of methods for using the embodiment of FIG. 1.

### DETAILED DESCRIPTION

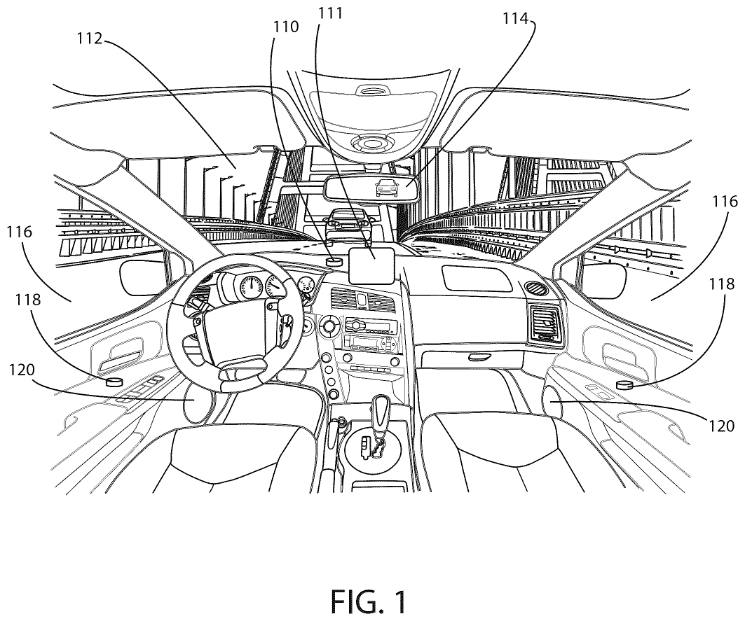

FIG. 1 shows an example embodiment 100 in a vehicle interior. A vehicle interface module, not shown, engages with the vehicle's CANbus to interface with sensor signals from the vehicle's operable components. Operable components may include pedals, a steering wheel, and an instrument cluster. Pedals may include a brake pedal, accelerator (and clutch pedal if present, which receives signals from a shift lever). The interface module gathers sensor data and transmits the data to a simulation control unit. One skilled in the art understands how electronic modules may connect to a CANbus.

The simulation control unit 111 is a central control unit that processes data from the vehicle interface module to manage the simulation environment. In this example embodiment, the simulation control unit 111 has a touch-screen user interface as shown.

In an example embodiment a projection system projects images on the vehicle's windscreen and side windows. A projector 110 projects an image 112 on the vehicle windscreen while projectors 118 project images on side windows 116. One skilled in the art understands that heads-up-display projectors project images on glass surfaces. Other iterations include various projection methods and glass-surface alterations that may make the glass temporarily opaque to produce a higher-resolution projected image. In some embodiments an additional projection system projects an image on a rearview mirror 114.

The vehicle interface module sends signals from the vehicle's operable components, and the simulation control unit 111 runs the simulation. The simulation control unit 111 generates code to signal the vehicle interface module to engage operable components to provide haptic feedback. In one example, the vehicle's electronic steering is used to provide resistance or to power the steering in accordance with the simulation. One skilled in the art understands how similar systems may be used to provide resistance to braking, changes in instrumentation in response to accelerator movement, changes in engine behavior according to clutch and shift movement, and the like. Haptic feedback in the form of sound is generated and played through a vehicle sound system 120.

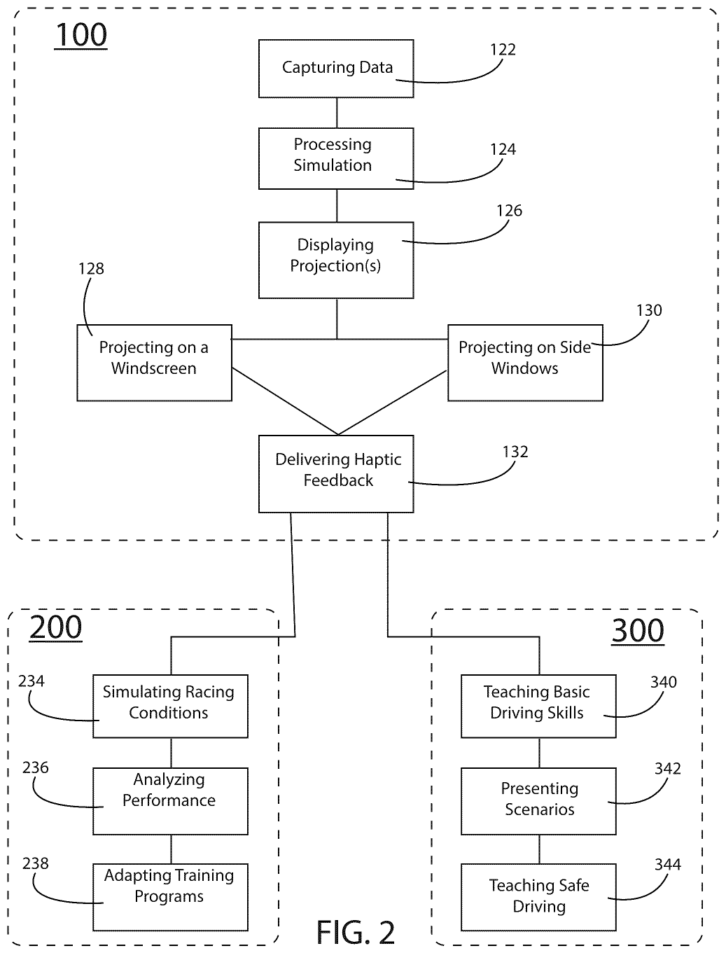

FIG. 2 is a graphic representation of a set of methods for using the embodiment of FIG. 1. In an example embodiment of the method, the method begins by capturing data 122. The vehicle interface module connects with the vehicle CANbus to capture real-time data from the vehicle's pedals (brake pedal, accelerator pedal and clutch pedal as per the vehicle's equipment), as well as from the vehicle's steering wheel and its instrument cluster, and transmits the data to the simulation control unit. The method continues by processing the simulation 124, wherein the simulation control unit processes the data and generates corresponding driving scenarios, including road conditions, traffic and environmental factors. The method follows by displaying projection(s) 126. The projection system uses heads-up display (HUD) technology to project the simulated driving environment by projecting on a windscreen 128 and by projecting on side windows 130. In some embodiments, the projection is achieved using transparent OLED displays or laser-projection technology. These projections create an augmented-reality experience in which virtual elements are seamlessly integrated with a real-world view. The method proceeds by delivering haptic feedback 132. Feedback mechanisms use existing electric steering systems to deliver haptic feedback through the steering wheel and pedals. Electric steering systems are ideal for this application because they can simulate various driving conditions and provide precise feedback to the driver without the need to move front wheels. The user interface allows the driver to adjust simulation settings and to receive performance feedback. One skilled in the art is familiar with modern electric steering systems and the use of electric resistance to provide various haptic feedback actions.

In an iteration of the embodiment 200, applications for advance driver skills may be demonstrated using the embodiment 100. A method for using the embodiment 200 involves simulating racing conditions 234 by allowing drivers to practice high-speed driving, cornering techniques and race strategies in a safe and controlled environment. The realistic feedback from the vehicle's controls helps drivers develop muscle memory and to fine-tune racing skills. The method further includes a module for analyzing performance 236 wherein the simulation control unit may record and analyze the driver's performance and give detailed feedback on aspects like braking efficiency, acceleration patterns, steering precision and, when a manual transmission is used, shifting and clutching technique. This data may identify areas for improvement and further tailor training programs to a driver's needs. The method has a module for adapting training programs 238 in which the system offers adaptive training programs that adjust a difficulty level commensurate with a driver's performance, ensuring continuous skill development and progression.

In another iteratin, 300, applications for basic driver skills may be demonstrated using the embodiment 100. The method is configured for teaching basic driving skills 340 such as the proper use of the accelerator, steering, brakes, clutch and shift to assist the student in understanding vehicle dynamics. The immersive environment helps new drivers gain confidence and to experience driving without the risks associated with real-world driving. The method continues by presenting various scenarios 342 portraying city driving, highway driving or parking maneuvers. This allows new drivers to experience a range of situations and to learn how to react appropriately. The method further includes a module for teaching safety 344 in which the system may simulate emergency situations such as sudden obstacles, unexpected actions by pedestrians or cyclists, or vehicle malfunctions. In other embodiments, undesirable conditions such as fog, snow, rain or icy roads may be simulated to assist new drivers in developing skills for safely handling unexpected events.

1. A system for adapting a vehicle for a user interface for driving simulation comprising:
a vehicle interface module configured to capture data from the vehicle's operable components; and
a simulation control unit configured to receive captured data from the vehicle interface module to process said captured data to create a simulated environment; and
a projection system configured to project the simulated environment; and
a user interface configured to allow a driver to interact with simulation settings.

2. The system of claim 1 wherein:
the projection system includes a windscreen projector; wherein
motion images of the simulated environment are projected on the windscreen by way of heads-up display technology.

3. The system of claim 1 wherein:
the projection system includes a side window projector for at least the vehicle's front-seat side windows.

4. The system of claim 1 wherein:
said projection system employes OLED display.

5. The system of claim 1 wherein:
said projection system employes laser-projection technology.

6. The system of claim 1 further comprising:
at least one mirror projector; wherein
simulated environmental images are projected on the at least one mirror.

7. The system of claim 1 further comprising:
a feedback mechanism electronically coupled with the simulation control unit and vehicle interface module configured to provide haptic feedback through the vehicle's operable components.

8. The system of claim 7 further comprising:
the feedback mechanism configured to provide haptic feedback through a vehicle's sound system.

9. A method for using the system of claim 1, the method comprising:
capturing data in the vehicle interface module; and
processing simulation in the simulation control unit to generate driving scenarios; and
displaying projections through the projection system; and
delivering haptic feedback by way of the vehicle's electronic control systems for the operable components.

10. The method of claim 9 wherein:
the vehicle interface module captures data including brake pressure, accelerator position, steering angle, and instrument cluster; wherein
the data is used to inform the simulation control unit in reaction to generated driving scenarios.

11. The method of claim 9 wherein:
driving scenarios include road conditions, traffic and environmental factors.

12. The method of claim 9 further comprising:
displaying simulation settings on the simulation control unit; and
providing for input by a user for adjusting simulation settings.

13. The method of claim 9 further comprising:
simulating racing conditions; and
analyzing racing performance; and
adapting training programs according to analyzed racing performance.

14. The method of claim 9 further comprising:
teaching driving skills; and
presenting traffic scenarios to test driving skills; and
teaching safe driving by presenting scenarios demonstrating safe driving; wherein
driving and safety skills are trained in a controlled, immersive environment.

15. The method of claim 9 wherein:
said driving scenarios relate to road racing.

16. The method of claim 9 wherein:
said driving scenarios relate to dragstrip racing.

17. The method of claim 9 wherein:
said driving scenarios relate to drifting.

18. The method of claim 9 wherein:
said driving scenarios relate to off-road racing.

19. The method of claim 9 wherein:
said driving scenarios relate to rock crawling racing.

20. The method of claim 9 wherein:
said driving scenarios relate to rally racing.
